(19) United States
(12) Patent Application Publication
(10) Pub. No.: US 2008/0276673 A1
(43) Pub. Date: Nov. 13, 2008

(54) METHOD FOR ADJUSTING A LOCK ASSEMBLY TO FIT WITH DIFFERENT KEYS

(75) Inventors: Chao-Ming Huang, Kangshan Chen (TW); Chi-Ming Chen, A-Lien Hsiang (TW)

Correspondence Address: PATENTTM.US, P. O. BOX 82788, PORTLAND, OR, 97282-0788, US

(73) Assignee: TAIWAN FU HSING INDUSTRIAL CO., LTD., Kangshan Chen (TW)

(21) Appl. No.: 11/966,638

(22) Filed: Dec. 28, 2007

(30) Foreign Application Priority Data
May 11, 2007 (TW) 096116784
Jun. 25, 2007 (TW) 096122857

(51) Int. Cl. E05B 27/04

(52) U.S. Cl. 70/490

(57) ABSTRACT

A method for adjusting a lock assembly includes steps of providing a lock assembly, inserting a first key into the lock assembly, rotating a lock cylinder with the first key to an operating position, moving the lock cylinder relative to a housing in a first moving direction, moving the lock cylinder relative to the housing in a second moving direction, removing the first key from the lock cylinder, inserting a second key into the lock cylinder and rotating the lock cylinder with the second key. Accordingly, to adjust the lock assembly to fit with different keys is convenient and quick.

### BACKGROUND OF THE INVENTION

1. Field of the Invention

The present invention relates to a method, and more particularly to a method for adjusting a lock assembly to fit with different keys.

2. Description of Related Art

A traditional lock assembly is only applied with a specific key and cannot fit with different keys. To use with different keys, an old lock cylinder should be replaced with a new one, such that the traditional lock assembly is not versatile in use.

To make a lock assembly fitting with different keys, a US patent application with publish number 2005/0011242 (referring to '242 application hereafter), entitled to “Rekeyable Lock Assembly” is provided. The '242 application comprises a plug body and carrier sub-assembly mounted in a lock cylinder body. The carrier sub-assembly is mounted on the plug body and comprises a carrier and a plurality of racks.

To adjust the lock cylinder to fit with different keys, an original corresponding key is inserted into the plug body and the plug body is rotated 90° in clockwise to make the carrier slidable in the lock cylinder body between two positions. A tool is then inserted into the plug body to push the carrier with the racks to move in an axial direction and disengage from pins in the lock cylinder body. After removing the original corresponding key and the tool from the plug body, a new key is inserted into the lock cylinder body and is rotated in counterclockwise to make the racks engaging the pins again. Consequently, the lock assembly can fit with the new corresponding key.

However, a specific tool is need for adjusting the lock assembly of the '242 application, and the tool is not an inherent part of the lock assembly. Therefore, the adjustment of the lock assembly of the '242 application is troublesome and time-consuming.

To overcome the shortcomings, the present invention tends to provide a lock assembly to mitigate or obviate the aforementioned problems.

### SUMMARY OF THE INVENTION

The main objective of the invention is to provide a method for adjusting a lock assembly to fit with different keys conveniently and quickly.

The method comprising steps of

providing a lock assembly comprising
a housing; and
a lock cylinder rotatably and slidably in the housing;

inserting a first key into the lock cylinder;

rotating the lock cylinder with the first key to an operating position;

moving the lock cylinder relative to the housing in a first moving direction;

moving the lock cylinder relative to the housing in a second moving direction;

removing the first key from the lock cylinder;

inserting a second key into the lock cylinder; and

rotating the lock cylinder with the second key to make the lock assembly fitting with the second key.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a lock assembly for a method in accordance with the present invention;

FIG. 2 is another exploded perspective view of the lock assembly in FIG. 1;

FIG. 3 is a perspective view in partial section of the lock assembly in FIG. 1;

FIG. 4 is a perspective view in partial section of the lock assembly in FIG. 1 with a key being inserted into the lock cylinder;

FIG. 5 is an exploded perspective view of a second embodiment of a lock assembly for a method in accordance with the present invention;

FIG. 6 is an exploded perspective view in partial section of a third embodiment of a lock assembly for a method in accordance with the present invention;

FIG. 7 is an exploded perspective view in partial section of a fourth embodiment of a lock assembly for a method in accordance with the present invention;

FIG. 8 is a perspective view of a first embodiment of an adjusting block of a lock assembly for a method in accordance with the present invention;

FIG. 9 is an operational top view in partial section of the adjusting block in FIG. 8 with a corresponding rack element;

FIG. 10 is an exploded perspective view of a second embodiment of an adjusting block and a rack element of a lock assembly for a method in accordance with the present invention;

FIG. 11 is an operational top view in partial section of the adjusting block and the corresponding rack element in FIG. 10;

FIGS. 12A to C are perspective views of embodiments of an adjusting base of a lock assembly for a method in accordance with the present invention;

FIG. 13 is a side view in partial section of the lock assembly in FIG. 1 showing that the lock assembly is in a locked condition;

FIGS. 14 to 19 are top and side views in partial section of the lock assembly in FIG. 1 showing the process of the lock assembly being adjusted to fit with different keys with the method in accordance with the present invention;

FIG. 20 is an exploded perspective view of a fifth embodiment of a lock assembly for a method in accordance with the present invention;

FIG. 21 is a perspective view in partial section of the lock assembly in FIG. 20;

FIG. 22 is a side view in partial section of the lock assembly in FIG. 20 showing that the lock assembly is in a locked condition;

FIG. 23 is an exploded perspective view of the recoiling device of the lock assembly in FIG. 20;

FIG. 24 is a side view in partial section of a sixth embodiment of a lock assembly for a method in accordance with the present invention; and

FIGS. 25 to 31 are top and side views in partial section of the lock assembly in FIG. 20 showing the process of the lock assembly being adjusted to fit with different keys with a method in accordance with the present invention.

### DETAILED DESCRIPTION OF PREFERRED EMBODIMENT

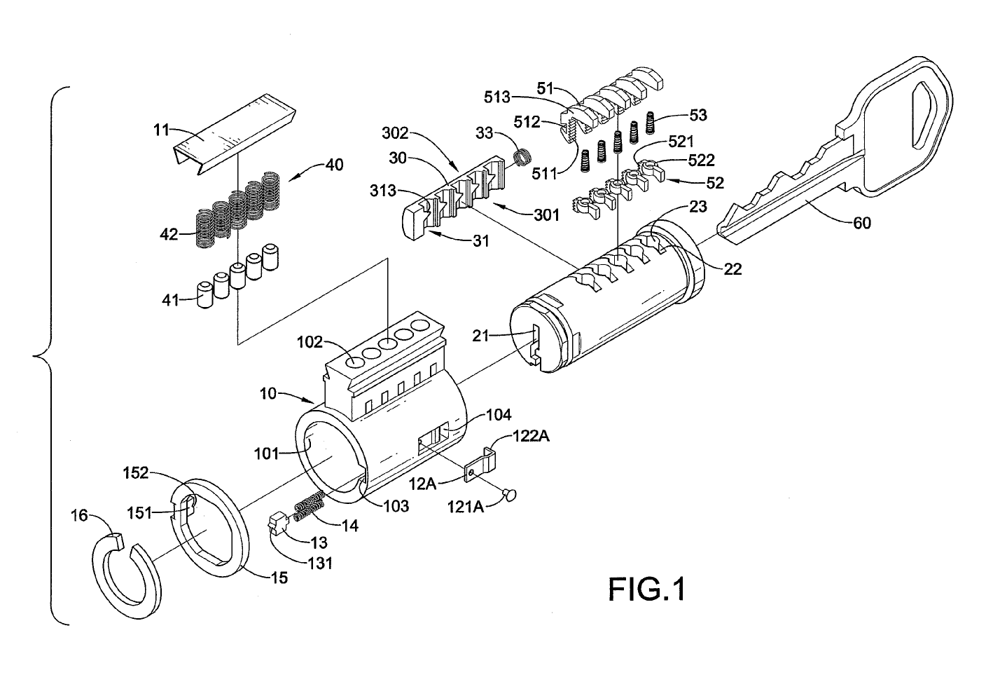

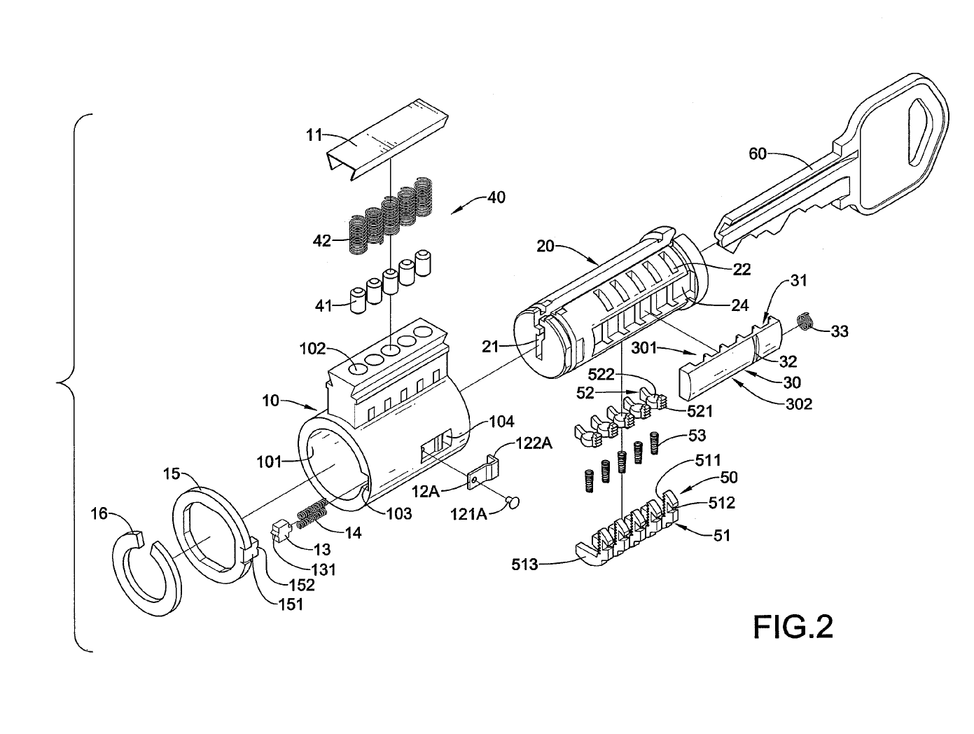

With reference to FIGS. 1 to 3, a lock assembly in accordance with the present invention comprises a housing (10), a lock cylinder (20), an adjusting block (30), an engaging member (12A), multiple pin assemblies (40) and multiple rack assemblies (50).

The housing (10) has a cylinder hole (101), multiple pin holes (102), a lid (11), a through hole (104) and a positioning element (13).

The cylinder hole (101) is defined axially through the housing (10). The pin holes (102) are defined radially in the housing (10) and communicate with the cylinder hole (101). The lid (11) is attached to the housing (10) and closes the pin holes (102). The through hole (104) is defined radially in the housing (10) and communicates with the cylinder hole (101).

The positioning element (13) is mounted on and extends from the housing (10). In a first embodiment, an alignment channel (103) is defined in an inner surface of the cylinder hole (101) at a rear end of the housing (10), and the positioning element (13) is slidably mounted in and extends out of the alignment channel (103). At least one spring (14) is mounted in the alignment channel (103) and abuts the positioning element (13) to push the positioning element (13) out of the alignment channel (103). The positioning element (13) may have a positioning tip (131) formed on and protruding from the positioning element (13).

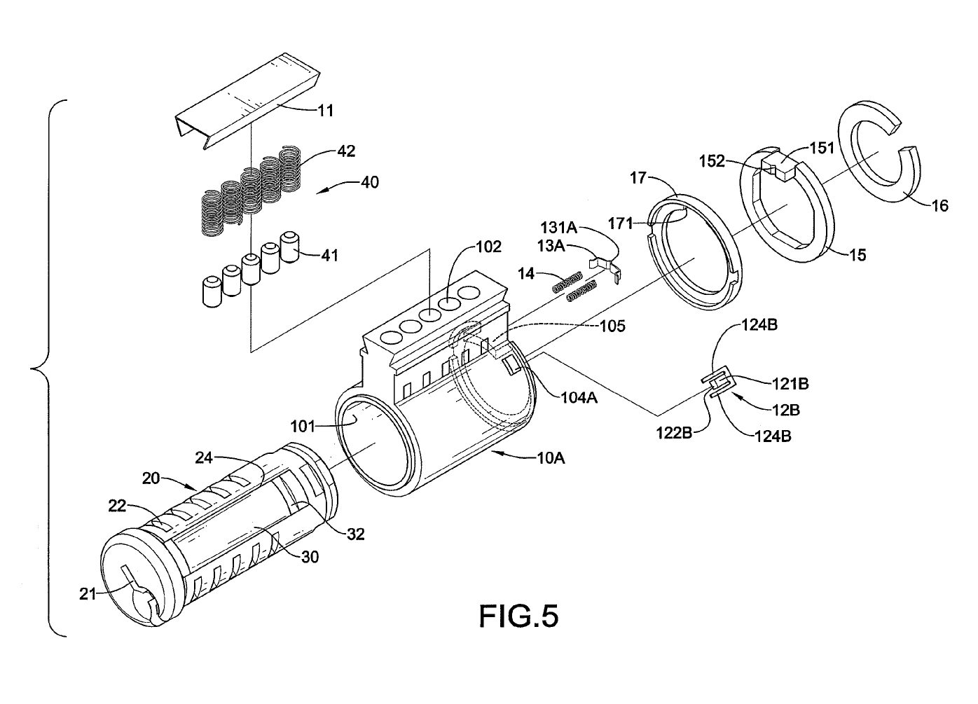

With reference to FIGS. 5 to 7, in an alternative embodiment, an alignment notch (105) is defined in a rear end of the housing (10A,10B), and the positioning element (13A) is mounted in and extends out of the alignment notch (105) and has a positioning tip (131A). Additionally, the housing (10A,10B) further has an annular cap (17,17A) mounted on a rear end of the housing (10A,10B) and is made of wear-resisting material. The annular cap (17,17A) has an aligning notch (171) aligning with the alignment channel (103) or the alignment notch (105) in the housing (10,10A,10B).

The lock cylinder (20) is rotatably and slidably mounted in the cylinder hole (101) in the housing (10) and comprises a key hole (21), multiple pin slots (22), a holding recess (24), a positioning collar (15) and a fastener (16).

The key hole (21) is defined axially through the lock cylinder (20). The pin slots (22) are defined radially in the lock cylinder (20), communicate with the key hole (21) and selectively and respectively correspond to and align with the pin holes (102) in the housing (10). Each pin slot (22) further has a pin bore (23) defined in an inner surface of the pin slot (22) and having a diameter larger than a width of the pin slot (22). The holding recess (24) is longitudinally defined in the lock cylinder (20) and communicates with the pin slots (22). The positioning collar (15) is mounted securely around and rotated with the lock cylinder (20) at a rear end, may abut the annular cap (17,17A) and has a positioning portion (151). With the wear-resisting annular cap (17,17A), the positioning collar (15) is kept from contacting with the rear end of the housing (10), such that the housing (10) is prevented from being worn off. The positioning portion (151) is formed on and protrudes from the positioning collar (15) and selectively engages the positioning element (13) in the alignment channel (103) of the housing (10). The positioning portion (151) may have a positioning detent (152) defined in the positioning portion (111) at an end facing the positioning element (13) and selectively engaging the positioning tip (131) on the positioning element (13) via the aligning notch (71) in the annular cap (17).

The fastener (16) is C-shaped or E-shaped and attached to a rear end of the lock cylinder (20) and abuts the positioning collar (15) to keep the lock cylinder (20) from escaping from the cylinder hole (101) in the housing (10).

The adjusting block (30) is slidably mounted on the lock cylinder (20), is preferably mounted in the holding recess (24) and has a wedge side (301), an engaging side (302), multiple first wedge elements (31) and an engaging slot (32).

The wedge side (301) faces the lock cylinder (20), and the engaging side (302) is opposite to the wedge side (301). The first wedge elements (31) are formed on the wedge side (301) and correspond respectively to the pin slots (22) in the lock cylinder (20).

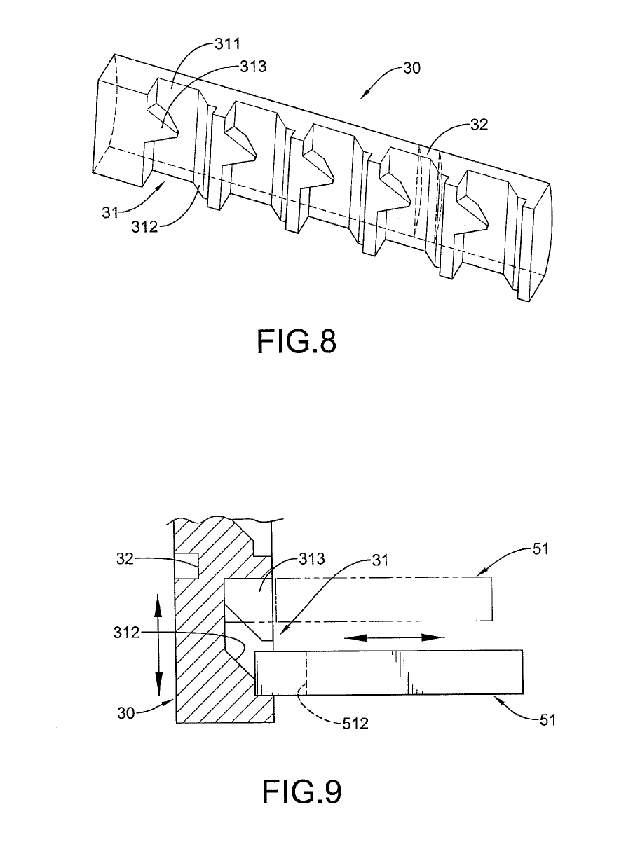

With further reference to FIGS. 8 and 9, in a first embodiment, each first wedge element (31) on the adjusting block (30) comprises a recess (311), an inclined guiding face (312) and a wedge tip (313). The recess (311) is defined in the wedge side (301) of the adjusting block (30) and has a front side and a rear side. The inclined guiding face (312) is defined in the front side of the recess (311). The wedge tip (313) is formed on the rear side of the recess (311), extends toward the front side and has two inclined wedge surfaces.

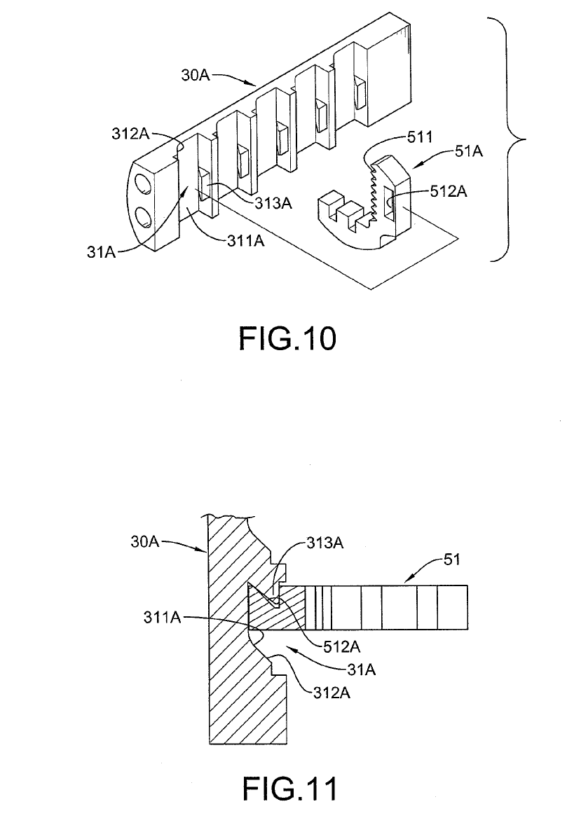

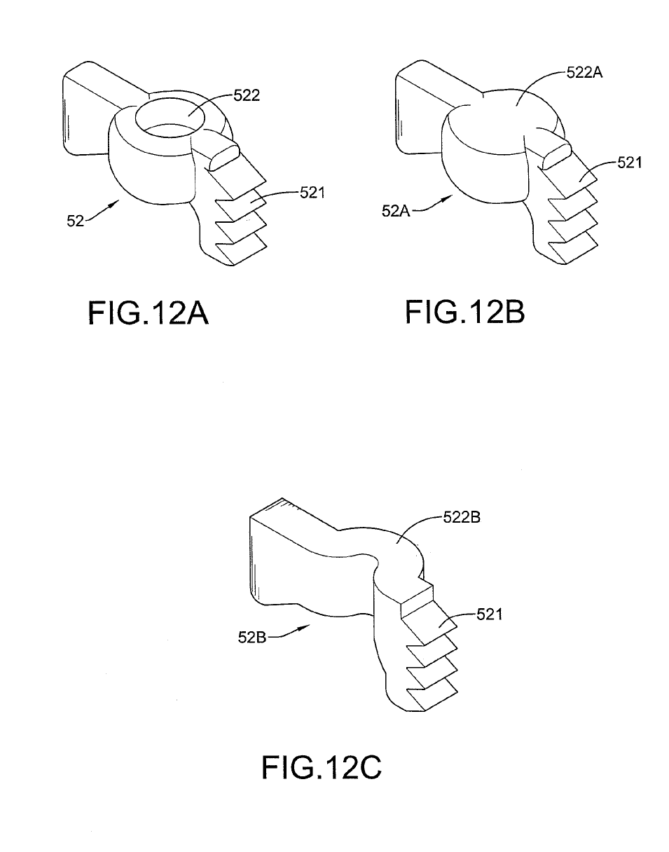

With reference to FIGS. 10 and 12, in a second embodiment, each first wedge element (31A) on the adjusting block (30A) comprises a recess (311A), an inclined guiding face (312A) and a wedge boss (313A). The recess (311A) is defined in the wedge side (301) of the adjusting block (30A) and has a front side and a rear side. The inclined guiding face (312A) is defined in the front side of the recess (311A). The wedge boss (313A) is formed on the rear side of the recess (311A) and has an inclined wedge surface (313A).

The engaging slot (32) is defined in the engaging side (302) of the adjusting block (30). Additionally, a biasing member (33), such as a spring is mounted in the holding recess (24) and abuts the adjusting block (30).

The engaging member (12A) is mounted on the housing (10) and extends into the cylinder hole (101) through the through hole (104).

In the first embodiment, with reference to FIGS. 1 to 3, the through hole (104) is defined in the housing (10) near a front end of the housing (10). The engaging member (12A) is a resilient strap and has a connecting end and an engaging end (122A). The connecting end is securely mounted on the housing (10) with a fastener (121A). The engaging end (122A) is bent from the connecting end, extends into the cylinder hole (101) through the through hole (104) in the housing (10) and detachably and selectively engages the engaging slot (32) in the adjusting block (30).

In a second embodiment, with reference to FIG. 5, the through hole (104A) is defined in the housing (10A) near a rear end of the housing (10A). The engaging member (12B) is a resilient strap, is attached to the rear end of the housing (10A) and has an engaging tab (121B) and two legs (124B). The engaging tab (121B) comprises an engaging end (122B) bent from one end of the engaging tab (121B), extending into the cylinder hole (101) through the through hole (104A) and selectively engaging the engaging slot (32) in the adjusting block (30). The legs (124B) are formed respectively on two sides of and being parallel with the engaging tab (121B) and extend into the cylinder hole (101) from the rear end of the housing (10A).

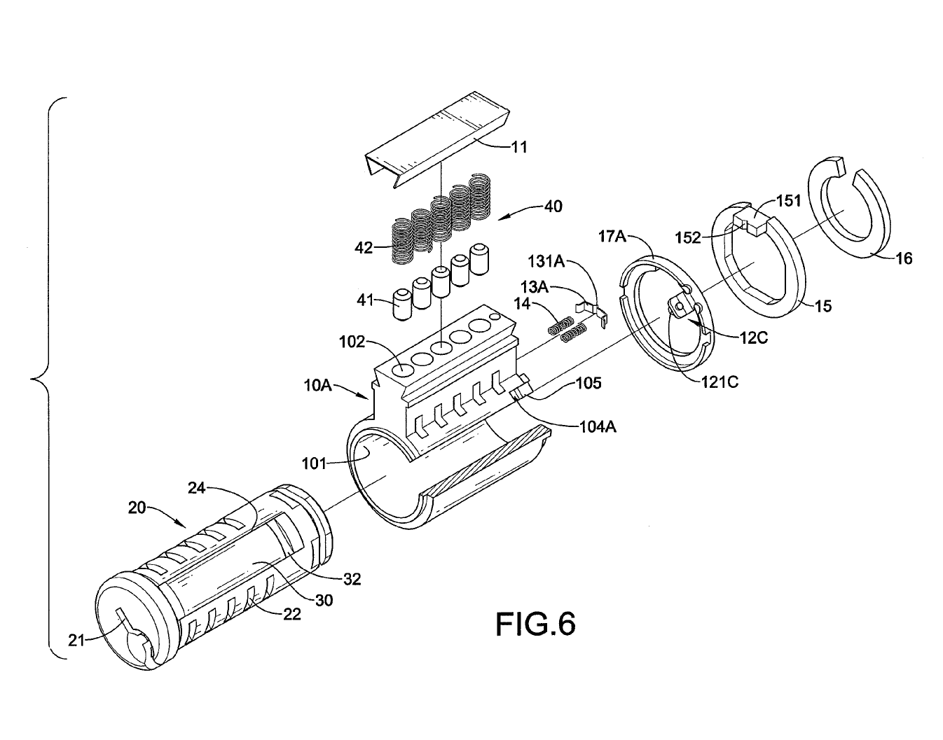

In a third embodiment, with reference to FIG. 6, the engaging member (12C) is formed on and protrudes from the annular cap (17A) and has a resilient tab and an engaging boss (121C). The resilient tab is formed on and protrudes from the annular cap (17A). The engaging boss (121C) is formed on the resilient tab, extends into the cylinder hole (101) through the through hole (104A) in the housing (10A) and selectively engaging the engaging slot (32) in the adjusting block (30).

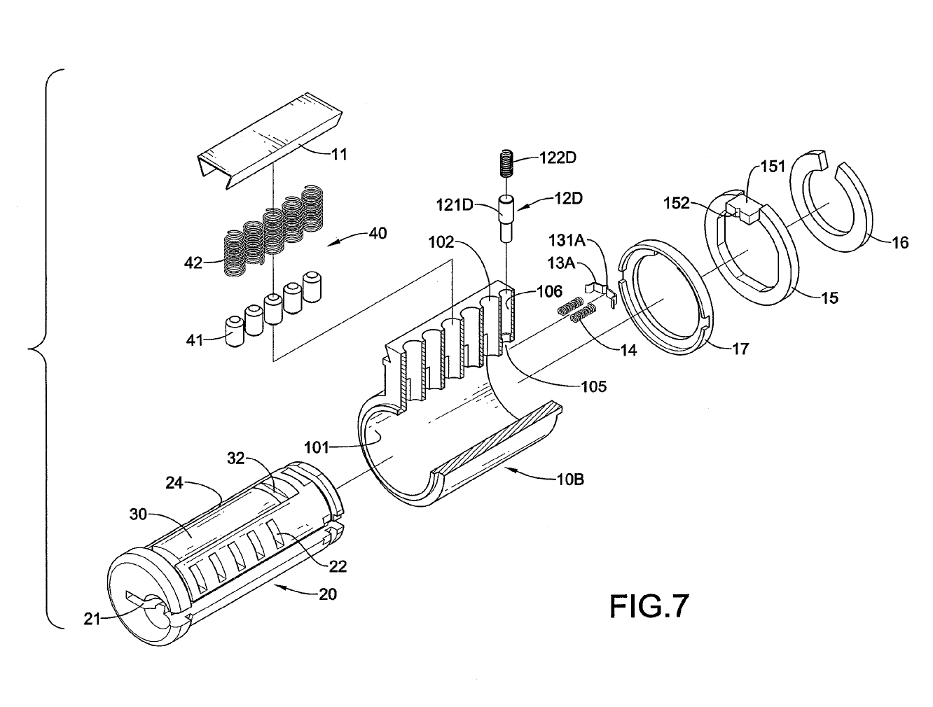

In a fourth embodiment, with reference to FIG. 7, the through hole (106) is defined in the housing (10B) near a rear end of the housing (10B) and aligns with the pin holes (102) in the housing (10B). The engaging member (12D) is mounted in the through hole (106) and has an engaging stud (121D) and a spring (122D). The engaging stud (121D) is mounted in the through hole (106), extends into the cylinder hole (101) and selectively engages the engaging slot (32) in the adjusting block (30). The spring (122D) is mounted in the through hole (106) and abuts and pushes the engaging stud (121D).

The lock pin assemblies (40) are mounted respectively in the pin holes (102) in the housing (10) and selectively extend respectively into the pin slots (22) in the lock cylinder (20), preferably extend into the pin bores (23) in the pin slots (22). Each lock pin assembly (40) comprises a lock pin (41) and a spring (42). The lock pin (41) is slidably mounted in one of the pin holes (102) in the housing (10) and selectively extends into the pin bore (23) of a corresponding one the pin slots (22) in the lock cylinder (20). The spring (42) is held in a corresponding pin hole (102) and abuts against the lock pin (41) and the lid (11) to push the lock pin (41) into the corresponding pin slot (22).

The rack assemblies (50) are mounted respectively in the pin slots (22) in the lock cylinder (20) to support the lock pins (41) of the lock pin assemblies (40). Each rack assembly (50) comprises a rack element (51), an adjusting base (52) and a resilient member (53). The rack element (51) may be L-shaped, is slidably mounted in one of the pin slots (22), selectively abuts with and supports a corresponding one of the lock pins (41) and has an extension arm (513), multiple teeth (511) and a second wedge element (512). The extension arm (513) is formed on and extends laterally from the top of the rack element (51). The teeth (511) and the second wedge element (512) are formed respectively at two sides of the rack element (51). The second wedge element (512) selectively engages one of the first wedge elements (31) on the adjusting block (30).

With further reference to FIG. 9, in a first embodiment, the second wedge element (512) on each rack element (51) comprises a notch defined in the second wedge element (512) at a side facing the adjusting block (30). The notch has two inclined wedge surfaces selectively abutting respectively with the inclined wedge surfaces of the wedge tip (313) on a corresponding first wedge element (31) on the adjusting block (30).

With further reference to FIGS. 10 and 11, in a second embodiment, the second wedge element (512A) on each rack element (51A) comprises a notch defined in the wedge element (51A) at a side facing the adjusting block (30A). The notch has an inclined wedge surface selectively abutting with the inclined wedge surface of the wedge boss (313A) on a corresponding first wedge element (31A) on the adjusting block (30A).

The adjusting base (52) is slidably mounted in a corresponding pin slot (22) and has multiple teeth (521) engaging the teeth (511) on the rack element (51) and a spring abutting portion (522). With the engagement between the teeth (511,521) on the rack element (51) and the adjusting base (52), the rack element (51) will move with the adjusting base (52) along the corresponding pin slot (22). The spring abutting portion (522) is formed on the adjusting base (52). In a first embodiment, with reference to FIG. 12A, the spring abutting portion (522) is a round cavity defined in the adjusting base (52). In a second embodiment, with reference to FIG. 12B, the spring abutting portion (522A) is a round block formed on a middle of the adjusting base (52A). In a third embodiment, with reference to FIG. 12C, the spring abutting portion (522B) is a C-shaped formed on a middle of the adjusting base (52B).

The resilient member (53) is mounted between the rack element (51) and the adjusting base (52). In a preferred embodiment, two ends of the resilient member (53) abut respectively with the extension arm (513) and the spring abutting portion (522) on the adjusting base (52).

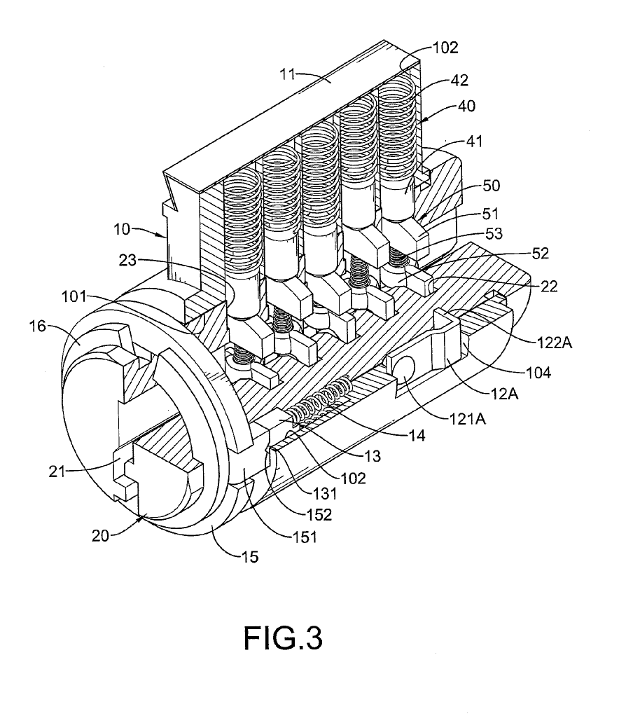

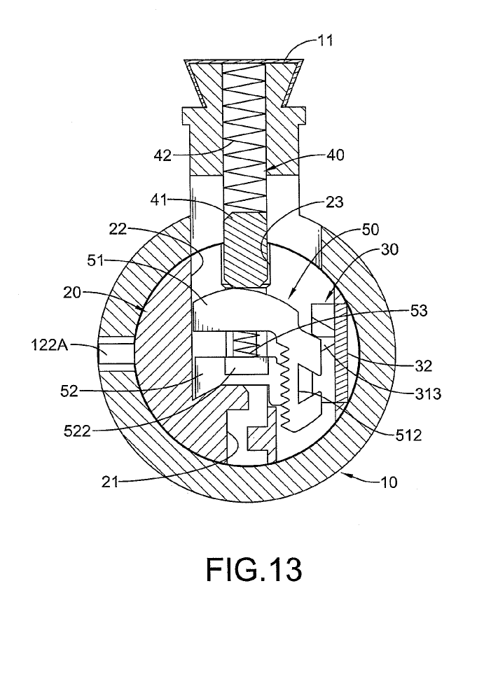

In use, with reference to FIGS. 3 and 13, before a specific key is inserted into the key hole (21), the lock pins (41) extend respectively into the pin bores (23) of the lock slots (22) in the lock cylinder (20). Thus, the interface between the housing (10) and the lock cylinder (20) is blocked by the lock pins (41) to keep the lock cylinder (20) from rotating relative to the housing (10), and the lock assembly is in a lock condition.

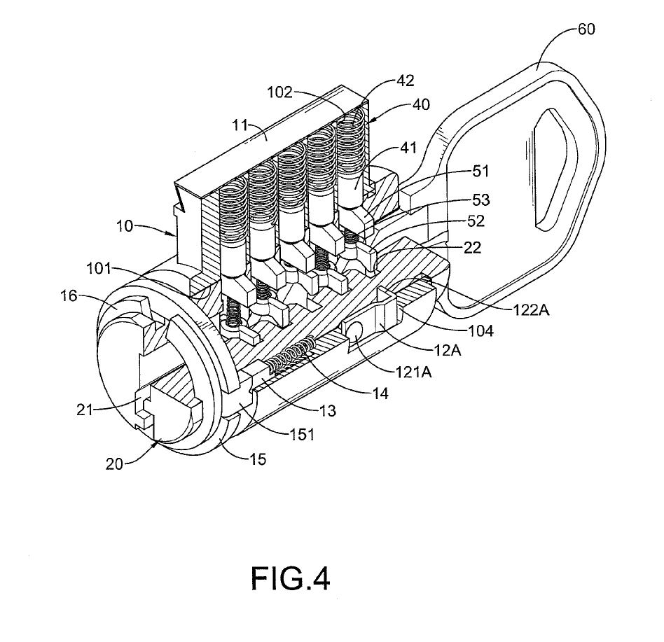

When a specific key (60) is inserted into the key hole (21), with reference to FIG. 4, the key pushes the adjusting bases (52) with the rack elements (51) to move upward along the pin slots (22) to a position where the joints between the lock pins (41) and the rack elements (51) align with the interface between the lock cylinder (20) and the housing (10). Consequently, the lock cylinder (20) can be rotated, and the lock assembly is in an unlocked condition.

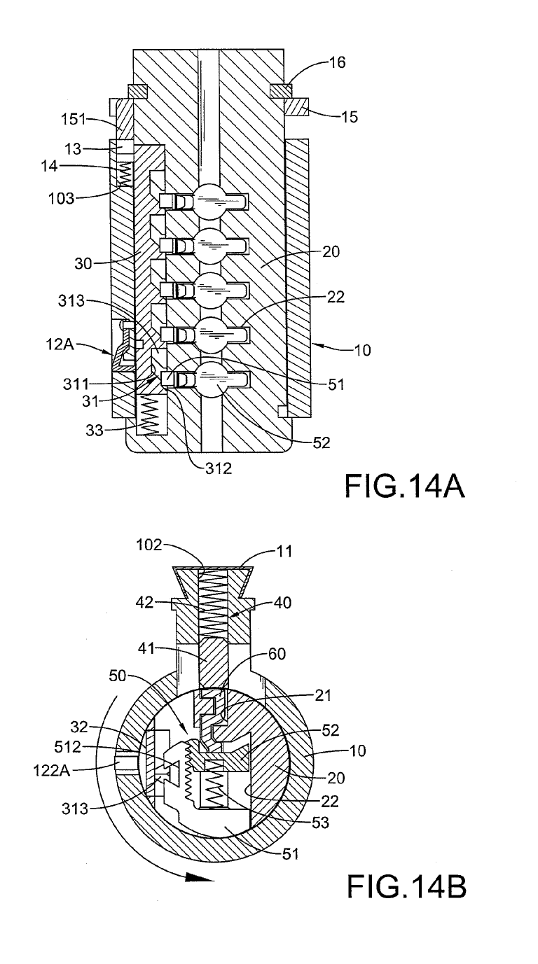

To adjust the lock assembly to fit with different keys, with reference to FIGS. 14 to 19, a first key (60) is inserted into the key hole (21) to unlock the lock assembly, and the lock cylinder (20) is then rotated to an operating position where the engaging slot (32) in the adjusting block (30) corresponds to and aligns with the engaging device (12A) as shown in FIGS. 14A and B in a first rotating direction. The first rotating direction may be clockwise. Additionally, the positioning collar (15) is rotated with the lock cylinder (20) to align and engage the positioning element (13). With the engagement between the positioning portion (151) on the positioning collar (15) and the positioning element (13), the necessary rotating angle of the lock cylinder (20) for aligning the adjusting block (30) with the engaging device (12A) is determined.

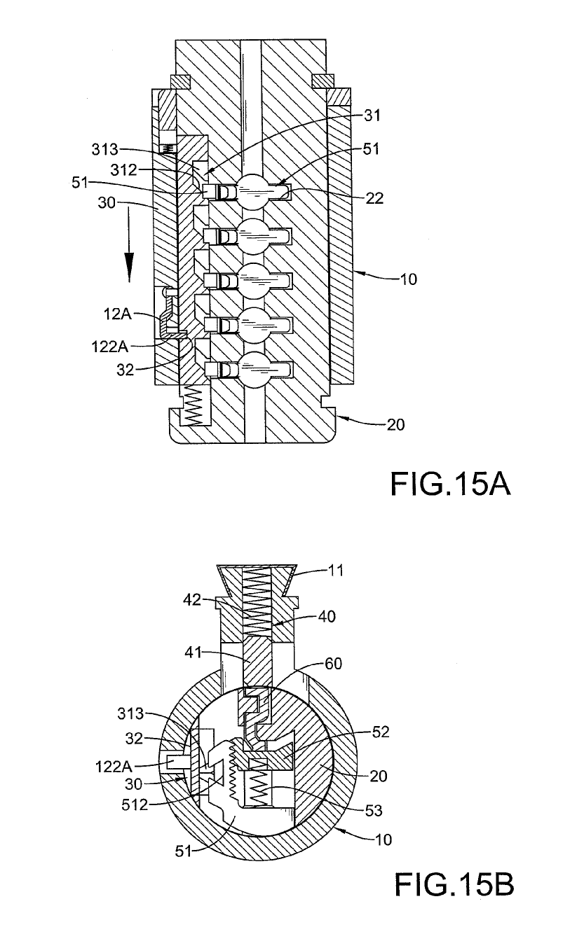

The lock cylinder (20) is moved in a first moving direction, such as pulled to slide in the cylinder hole (101) to make the engaging device (12A) engaging the engaging slot (32) in the adjusting block (30) as shown in FIGS. 15A and B. With the engagement between the device (12A) and the slot (32), the adjusting block (30) is kept from moving with the lock cylinder (20).

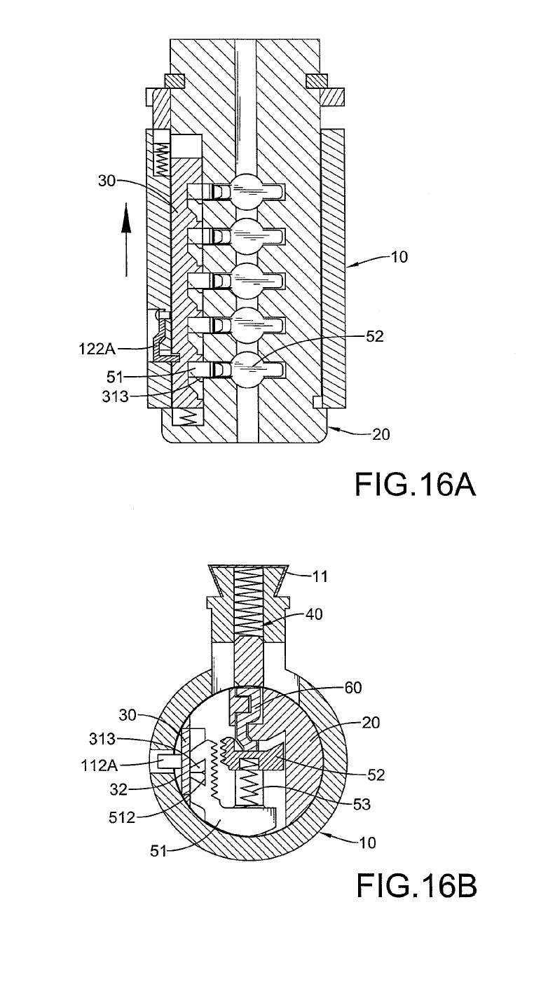

The lock cylinder (20) is then moved in a second moving direction, such as pushed, the adjusting block (30) is kept stationary and the rack elements (51) are moved with the lock cylinder (20) and relative to the adjusting block (30). Consequently, the rack elements (51) will move away from the adjusting bases (52) with the inclined surfaces (312) of the first wedge elements (31) on the adjusting block (30) as shown in FIGS. 9 and 11. Thus, the rack elements (51) are disengaged from the adjusting bases (52) as shown in FIGS. 16A and B.

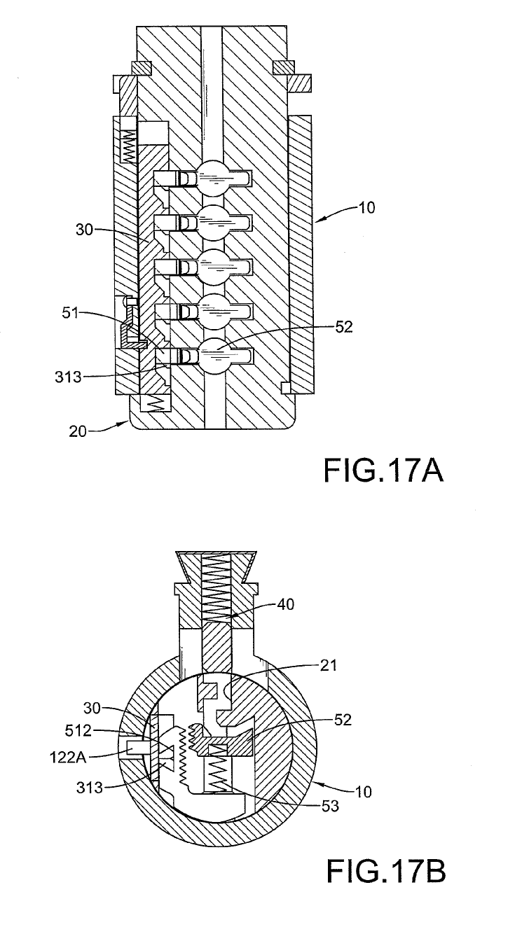

The first key (60) is removed from the key hole (21), as shown in FIGS. 17A and B.

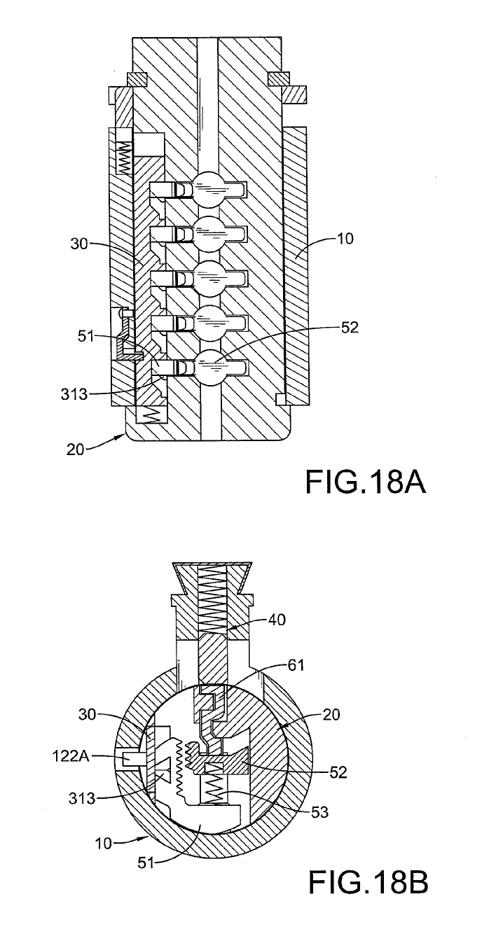

A second key (61) is then inserted into the key hole (21) to support the adjusting bases (52) at different positions from those supported by the first key (60) as shown in FIGS. 18 A and B.

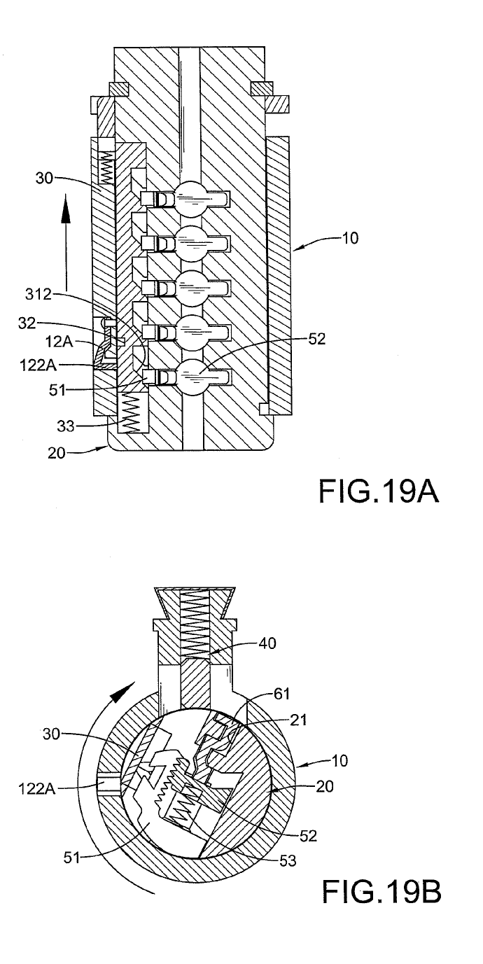

Finally, the lock cylinder (20) is rotated by the second key (61) as shown in FIGS. 19A and B in a second rotating direction. The second rotating direction may be opposite to the first rotating direction and may be counterclockwise. With the rotation of the lock cylinder (20), the adjusting block (30) will disengage from the engaging device (12A) and move to an original position with the force provided by the biasing member (33). With the movement of the adjusting block (30), the rack elements (51) are pushed to move close to and engage the adjusting bases (52). Because the adjusting bases (52) are located at different positions, the teeth (521) on the adjusting bases (52) engage different teeth (511) on the rack elements (51). Thus, the rack elements (51) support the lock pins (41) at different positions to fit with the second key (61).

Accordingly, to adjust the lock assembly in accordance with the present invention is convenient and quick without using any tool, so that the lock assembly is versatile in use.

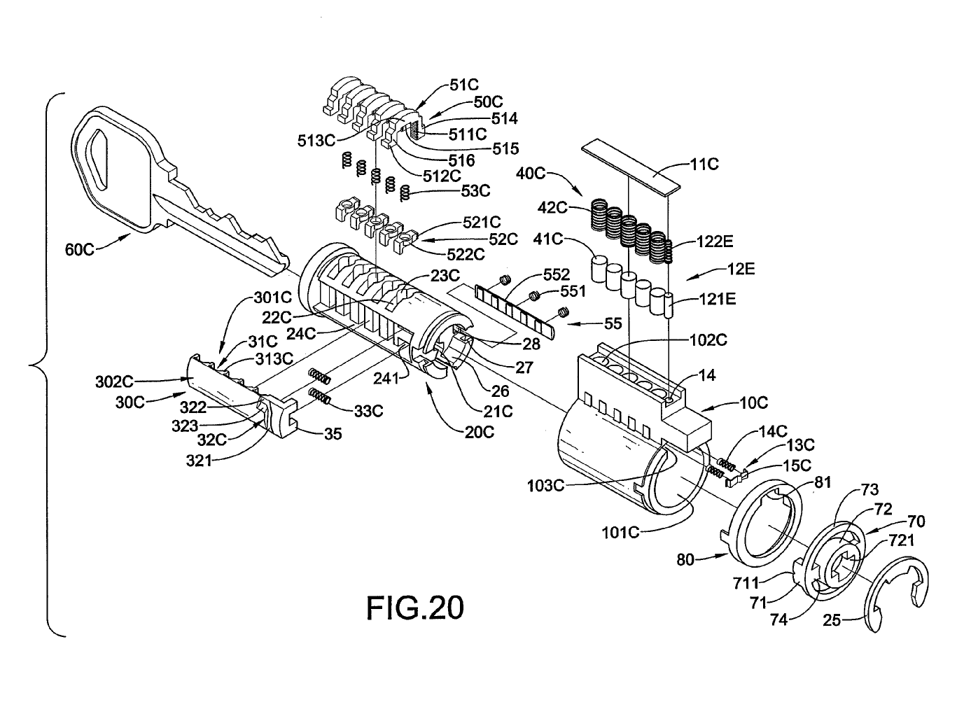

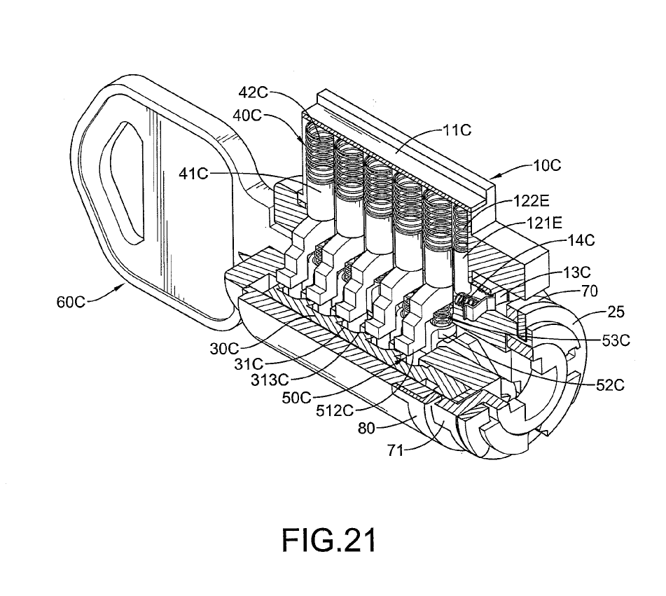

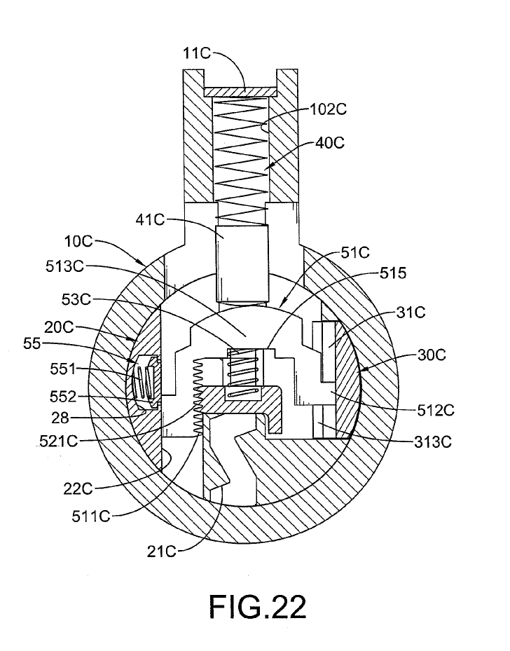

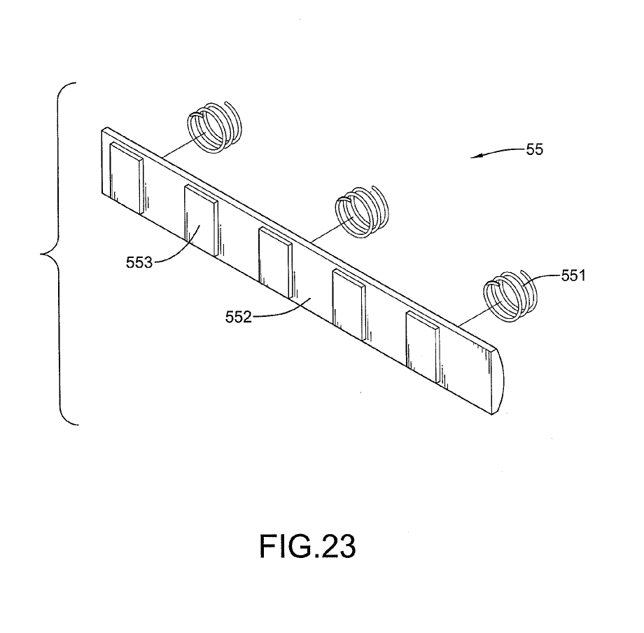

With reference to FIGS. 20 to 22, a fifth embodiment of a lock assembly for a method in accordance with the present invention comprises a housing (10C), a lock cylinder (20C), an adjusting block (30C), multiple pin assemblies (40C) and an adjusting assembly.

The housing (10C) has a cylinder hole (101C), multiple pin holes (102C), a lid (11C), a through hole (104C), an engaging member (12E) and a positioning element (13C).

The cylinder hole (101C) is defined axially through the housing (10C). The pin holes (102C) are defined radially in the housing (10) and communicate with the cylinder hole (101C). The lid (11C) is attached to the housing (10C) and closes the pin holes (102C). The through hole (104C) is defined radially in the housing (10C), communicates with the cylinder hole (101C) and may align with the pin holes (102C).

The engaging member (12E) is mounted in the through hole (104C), may be a stud (121E) and further comprises a spring (122E). The spring (122E) is mounted in the through hole (104C) and abuts and pushes the engaging member (12E).

The positioning element (13C) is mounted on and extends from the housing (10C). In a preferred embodiment, an alignment notch (103C) is defined in a rear end of the housing (10C), and the positioning element (13C) is held in and extends out of the alignment notch (103C). At least one spring (14C) is mounted in the alignment notch (103C) and abuts the positioning element (13C) to push the positioning element (13C) out of the alignment notch (103C). The positioning element (13C) may have a positioning tip (15C) formed on and protruding from the positioning element (13C).

The housing (10C) further has an annular cap (80) mounted on the rear end of the housing (10C) and is made of wear-resisting material. The annular cap (80) has an aligning notch (81) aligning with the alignment notch (103C) in the housing (10C).

The lock cylinder (20C) is rotatably and slidably mounted in the cylinder hole (101C) in the housing (10C) and comprises a key hole (21C), multiple pin slots (22C), a holding recess (24C), a dungeon (26), a recoiling channel (28), a positioning collar (70) and a fastener (25).

The key hole (21C) is defined axially through the lock cylinder (20C). The pin slots (22C) are defined radially in the lock cylinder (20C), communicate with the key hole (21C) and selectively and respectively correspond to and align with the pin holes (102C) in the housing (10C). Each pin slot (22C) further has a pin bore (23C) defined in an inner surface of the pin slot (22C) and having a diameter larger than a width of the pin slot (22C). The holding recess (24C) is longitudinally defined in the lock cylinder (20C) and communicates with the pin slots (22C). The holding recess (24C) has a spring cavity (241) defined in a bottom at an end of the channel (24C). The dungeon (26) is defined in the rear end of the lock cylinder (20C) and has at least one slit (27) defined in the rear end of the lock cylinder (20C) and communicating with the dungeon (26). The recoiling channel (28) is defined longitudinally inside the lock cylinder (20C) and communicates with the pin slots (22C) and the dungeon (26).

The positioning collar (70) is mounted securely around the rear end of and rotated with the lock cylinder (20C), may abut the annular cap (80) and comprises an inner ring (72), an outer ring (73), at least one connecting rib (74) and a positioning portion (71). With the wear-resisting annular cap (80), the positioning collar (70) is kept from contacting with the rear end of the housing (10C), such that the housing (10C) is prevented from being worn off.

The inner ring (72) is held inside the dungeon (26) in the lock cylinder (20C) and has a connecting hole (721) defined through the inner ring (72). The connecting hole (721) may have a shape of character 8 and is adapted to connect with a lock latch to make the latch rotating with the lock cylinder (20C) with the transmission of the positioning collar (70).

The outer ring (73) is mounted around the inner ring (72) and the rear end of the lock cylinder (20C). The at least one connecting rib (74) is mounted between the inner and outer rings (72,73) to connect the rings (72,73) together and is held respectively in the at least one slit (26) in the lock cylinder (20C). With the engagement between the ribs (74) and the slits (26), the positioning collar (70) is rotated with the lock cylinder (20C).

The positioning portion (71) is formed on and protrudes from the positioning collar (70) and selectively engages the positioning element (13C) in the alignment notch (103C) of the housing (10C). The positioning portion (71) may have a positioning detent (711) defined in the positioning portion (71) at an end facing the positioning element (13C) and selectively engaging the positioning tip (15C) on the positioning element (13C) via the aligning notch (81) in the annular cap (80).

The fastener (25) is C-shaped or E-shaped and attached to the rear end of the lock cylinder (20C) to keep the lock cylinder (20C) from escaping from the cylinder hole (101C) in the housing (10C) and hold the positioning collar (70) in position at the lock cylinder (20C).

The adjusting block (30C) is slidably mounted on the lock cylinder (20C), is preferably mounted in the holding recess (24C) and has a wedge side (301C), an engaging side (302C), multiple first wedge elements (31C), an engaging slot (32C), at least one biasing member (33C) and a spring mount (35).

The wedge side (301C) faces the lock cylinder (20), and the engaging side is opposite to the wedge side (301C). The first wedge elements (31C) are formed on the wedge side (301C) and correspond respectively to the pin slots (22C) in the lock cylinder (20C). The first wedge elements (31C) are formed separately on the wedge side (301C) of the adjusting block (30C) and each first wedge element (31C) on the adjusting block (30) comprises an inclined guiding face (313C) defined in a rear side of the first wedge element (31C).

The engaging slot (32C) is defined in the engaging side (302C) of the adjusting block (30) and selectively engages the engaging member (12E) to keep the adjusting block (30C) from moving with the lock cylinder (20C). The engaging slot (32C) has two long edges (321) perpendicular to an axis of the adjusting block (30) and two short edges perpendicular to the long edges (321).

The engaging slot (32C) may have a guiding notch (322) defined in one of the short edges to make the slot (32C) substantially L-shaped and provides a guiding effect to the engaging member (12E) entering into or escaping from the slot (32C). With the arrangement of the guiding notch (322), the escape of the engaging member (12E) from the slot (32C) can be postponed. The guiding notch (322) has an inclined guiding surface (323) extending to the engaging slot (32C) to provide a guiding effect to the engaging member (12E).

The spring mount (35) is formed on one end of the adjusting block (30C).

The biasing members (33C), such as springs are mounted in the spring cavity (241) in the holding recess (24C) and each have two end abut respectively the spring mount (35) on the adjusting block (30C) and an inner surface of the spring cavity (241).

The lock pin assemblies (40C) are mounted respectively in the pin holes (102C) in the housing (10C) and selectively extend respectively into the pin slots (22C) in the lock cylinder (20C), preferably extend into the pin bores (23C) in the pin slots (22C). Each lock pin assembly (40C) comprises a lock pin (41C) and a spring (42C) and has a structure same as that in the previous embodiments.

The adjusting assembly is mounted in the lock cylinder (20) and comprises multiple rack assemblies (50C) and a recoiling device (55).

The rack assemblies (50C) are adjustable and are mounted respectively in the pin slots (22C) to support the lock pins (41C). Each rack assembly (50C) comprises a rack element (51C), an adjusting base (52C) and a resilient member (53C).

The rack element (51C) may be inverse U-shaped, is slidably mounted in one of the pin slots (22C), selectively abuts with and supports a corresponding one of the lock pins (41C) and has a supporting arm (513C), a wedge leg (516) and an engaging leg (514). The supporting arm (513C) has a spring cavity (515) defined in a bottom of the supporting arm (513C). The wedge leg (516) and the engaging leg (514) are formed respectively on and protrude downward from two ends of the supporting arm (513C).

The wedge leg (516) extends into the holding recess (24C) and corresponds to and selectively engages one of the first wedge elements (31C) on the adjusting block (30C). The wedge leg (516) has a second wedge element (512C) formed on the wedge leg (516) and selectively engages a corresponding first wedge element (31C) on the adjusting block (30).

The engaging leg (514) has multiple teeth (511C) formed on a side facing the wedge leg (516).

The adjusting base (52C) is slidably mounted in a corresponding pin slot (22C) and has multiple teeth (521C) engaging the teeth (511C) on the rack element (51C) and a spring abutting portion (522C). With the engagement between the teeth (511C,521C) on the rack element (51C) and the adjusting base (52C), the rack element (51C) will move with the adjusting base (52C) along the corresponding pin slot (22C).

The spring abutting portion (522C) is formed on the adjusting base (52C) and has a round cavity defined in the spring abutting portion (522C).

The resilient member (53C) is mounted between the rack element (51C) and the adjusting base (52C). In a preferred embodiment, two ends of the resilient member (53C) are held respectively in the spring cavity (515) in the extension arm (513C) and the cavity (523) in the spring abutting portion (522C) on the adjusting base (52C).

The recoiling device (55) is mounted in the recoiling channel (28) in the lock cylinder (20C) to provide a recoiling force to the rack elements (51C) and comprises a pushing rod (552) and multiple resilient elements (551). With further reference to FIG. 4, the pushing rod (552) has multiple pushing bosses (553) formed on one side of the pushing rod (552) and abutting respectively with the engaging legs (514) of the rack elements (51C). The resilient elements (551), such as springs abut with the pushing rod (552). In a preferred embodiment, two ends of the resilient member (53C) are held respectively in the spring cavity (515) in the extension arm (513C) and the cavity in the spring abutting portion (522C) on the adjusting base (52C).

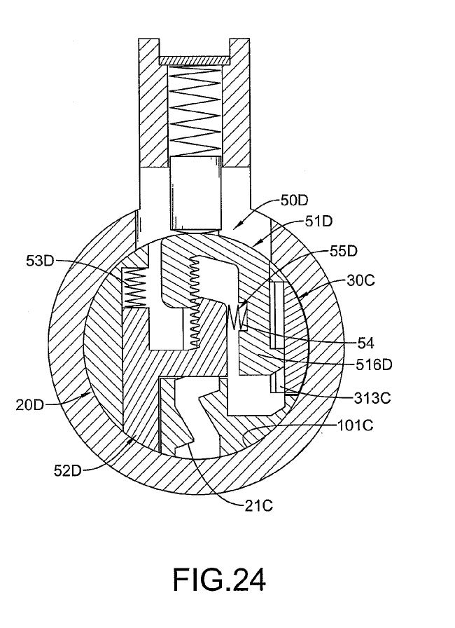

In an alternative embodiment, with reference to FIG. 24, the recoiling device (55D) comprises multiple resilient elements (54) each mounted between the wedge leg (516D) of a corresponding rack element (51D) and the corresponding adjusting base (52D). The resilient member (53D) of each rack assembly (50D) is mounted between the adjusting base (52D) and an inner surface of the lock cylinder (20D).

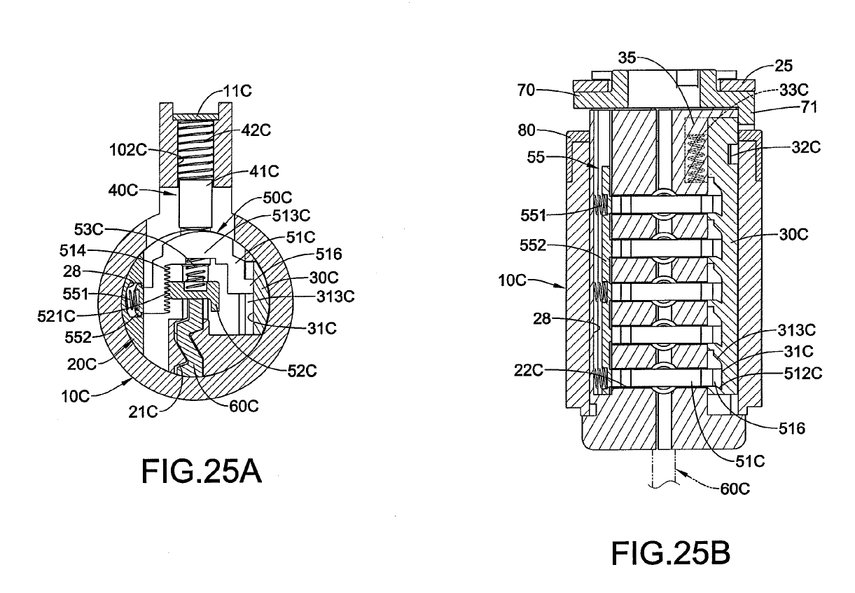

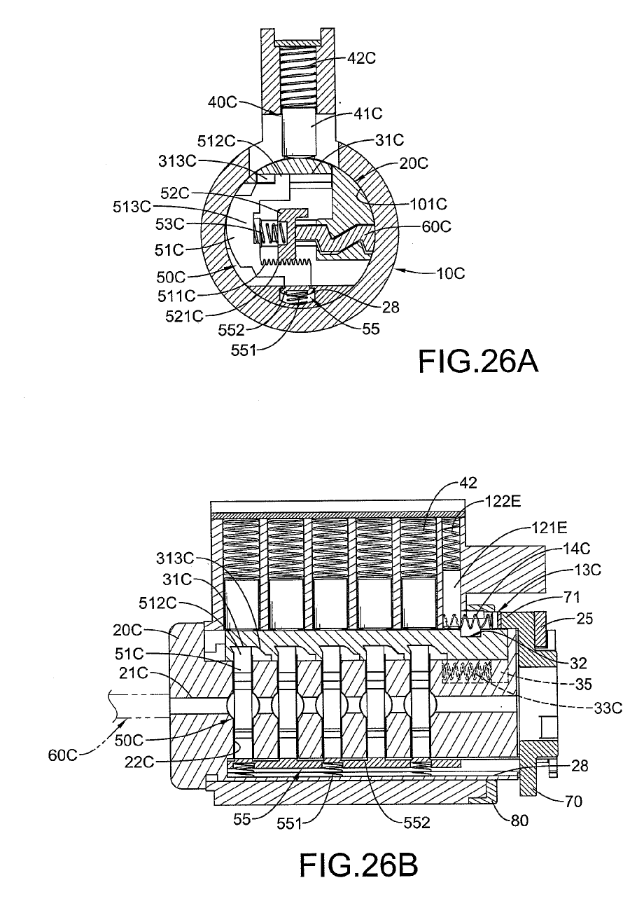

To adjust the lock assembly to fit with different keys, with reference to FIGS. 25 to 31, a first key (60C) is inserted into the key hole (21C) to unlock the lock assembly as shown in FIGS. 25A and B. The lock cylinder (20C) is then rotated to an operating position where the positioning position (71) on the positioning collar (70) aligns and engages the positioning element (13C) as shown in FIGS. 26A and B. At the same time, the engaging slot (32C) in the adjusting block (30C) corresponds to and aligns with the engaging device (12E). The engaging device (12E) enters into the guiding notch (322) from a corresponding short edge of the engaging slot (32C). With the engagement between the positioning portion (71) on the positioning collar (70) and the positioning element (13C), the necessary rotating angle of the lock cylinder (20C) for aligning the adjusting block (30C) with the engaging device (12E) is determined.

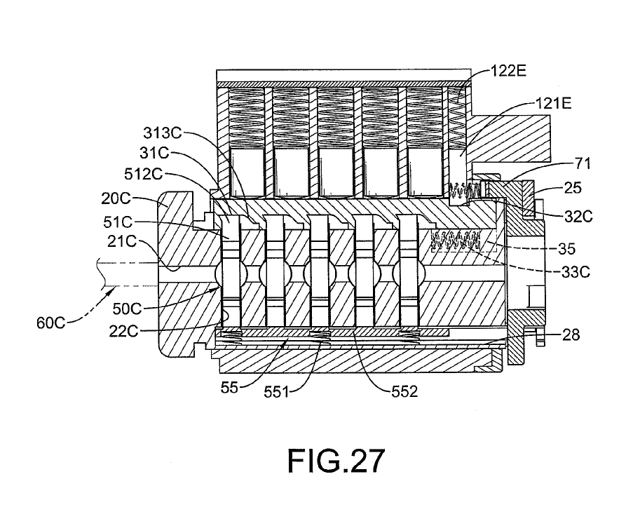

The lock cylinder (20C) is moved, such as pulled to slide in the cylinder hole (101C) to make the engaging device (12E) entering into and engaging the engaging slot (32C) with the guiding effect provided by the inclined guiding surface (323) and the pushing force provided by the spring (122E) as shown in FIG. 27. With the engagement between the engaging device (12E) and the slot (32C), the adjusting block (30C) is kept from moving with the lock cylinder (20C).

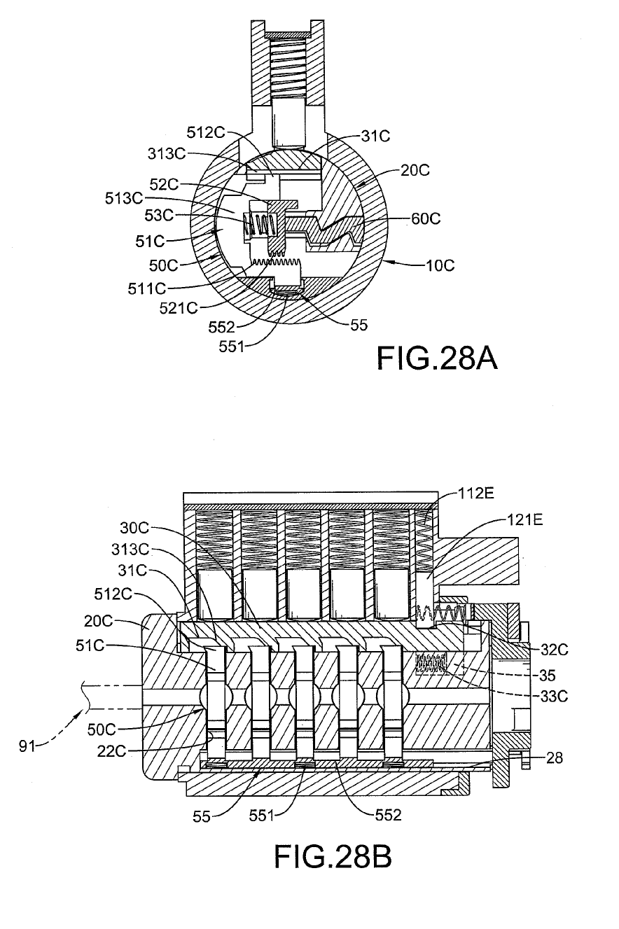

The lock cylinder (20C) is then moved in a reverse direction, such as pushed, the adjusting block (30C) is kept stationary and the rack elements (51C) are moved with the lock cylinder (20C) and relative to the adjusting block (30C). Consequently, the rack elements (51C) will move away from the adjusting bases (52C) with the inclined guiding faces (313C) of the first wedge elements (31C) on the adjusting block (30C) as shown in FIGS. 28A and B. Thus, the rack elements (51C) are disengaged from the adjusting bases (52C).

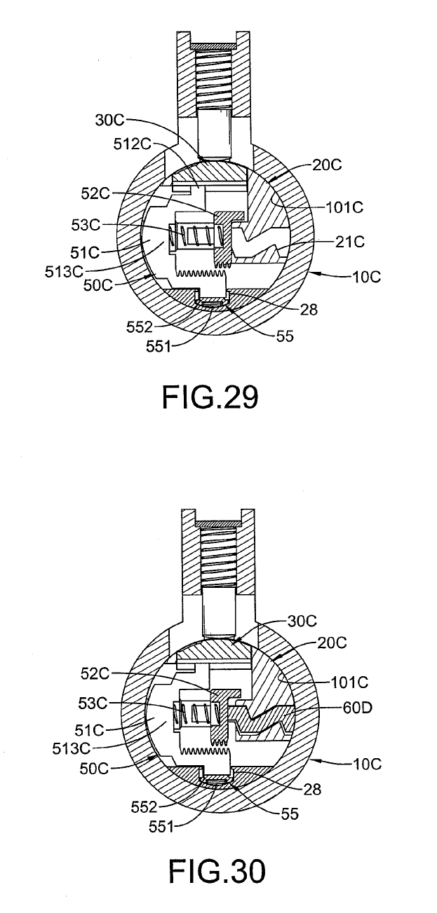

The first key (60C) is removed from the key hole (21C), as shown in FIG. 29.

A second key (60D) is then inserted into the key hole (21C) to support the adjusting bases (52C) at different positions from those supported by the first key (60D) as shown in FIG. 30.

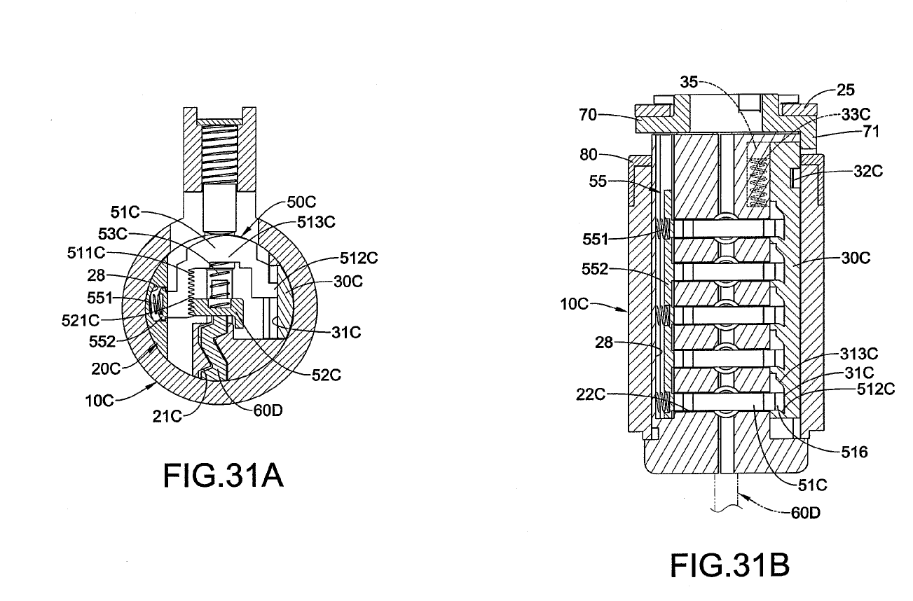

Finally, the lock cylinder (20C) is rotated by the second key (60D) as shown in FIGS. 31A and B. With the rotation of the lock cylinder (20C), the adjusting block (30C) will disengage from the engaging device (12E) and move to an original position with the force provided by the biasing members (33C). With the movement of the adjusting block (30C), the rack elements (51C) are pushed to move close to and engage the adjusting bases (52C). Because the adjusting bases (52C) are located at different positions, the teeth (521C) on the adjusting bases (52C) engage different teeth (511C) on the rack elements (51C). Thus, the rack elements (51C) support the lock pins (41C) at different positions to fit with the second key (60D). Additionally, with the recoiling force provided by the recoiling device (55), the rack elements (51C) can be moved to engage the adjusting bases (52C) precisely and stably.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for adjusting a lock assembly to fit with different keys comprising steps of
providing a lock assembly comprising
a housing; and
a lock cylinder rotatably and slidably in the housing;
inserting a first key into the lock cylinder;
rotating the lock cylinder with the first key to an operating position;
moving the lock cylinder relative to the housing in a first moving direction;
moving the lock cylinder relative to the housing in a second moving direction;
removing the first key from the lock cylinder;
inserting a second key into the lock cylinder; and
rotating the lock cylinder with the second key to make the lock assembly fitting with the second key.

2. The method as claimed in claim 1, wherein
the lock assembly further comprises
an adjusting block slidably mounted on the lock cylinder and selectively engaging with the housing; and
multiple adjustable rack assemblies mounted in the lock cylinder and each comprising
a rack element selectively engaging with the adjusting block; and
an adjusting base detachably engaging with the rack element;
the step of moving the lock cylinder relative to the housing in the first moving direction is making the adjusting block engaging with the housing;
the step of moving the lock cylinder relative to the housing in the second moving direction is disengaging the rack elements from the adjusting bases by the adjusting block and engaging the rack elements with the adjusting block;
the step of inserting a second key into the lock cylinder is making the second key supporting the adjusting bases at different positions; and
the step of rotating the lock cylinder with the second key is disengaging the rack elements from the adjusting block and engaging the rack elements with the adjusting bases.

3. The method as claimed in claim 2, wherein the second moving direction is opposite to the first moving direction.

4. The method as claimed in claim 3, wherein the step of moving the lock cylinder relative to the housing in the first moving direction is pulling the lock cylinder relative to the housing; and
the step of moving the lock cylinder relative to the housing in the second moving direction is pushing the lock cylinder relative to the housing.

5. The method as claimed in claim 4, wherein
the step of rotating the lock cylinder with the first key to the operating position is rotating the lock cylinder in a first rotating direction; and
the step of rotating the lock cylinder with the second key is rotating the lock cylinder in a second rotating direction opposite to the first rotating direction.

6. The method as claimed in claim 5, wherein the first rotating direction for rotating the lock cylinder with the first key is clockwise.

7. The method as claimed in claim 2, wherein
the step of rotating the lock cylinder with the first key to the operating position is rotating the lock cylinder in a first rotating direction; and
the step of rotating the lock cylinder with the second key is rotating the lock cylinder in a second rotating direction opposite to the first rotating direction.

8. The method as claimed in claim 1, wherein the second moving direction is opposite to the first moving direction.

9. The method as claimed in claim 7, wherein the step of moving the lock cylinder relative to the housing in the first moving direction is pulling the lock cylinder relative to the housing; and
the step of moving the lock cylinder relative to the housing in the second moving direction is pushing the lock cylinder relative to the housing.

10. The method as claimed in claim 1, wherein the step of moving the lock cylinder relative to the housing in the first moving direction is pulling the lock cylinder relative to the housing.

11. The method as claimed in claim 1, wherein the step of moving the lock cylinder relative to the housing in the second moving direction is pushing the lock cylinder relative to the housing.

12. The method as claimed in claim 1, wherein
the step of rotating the lock cylinder with the first key to the operating position is rotating the lock cylinder in a first rotating direction; and
the step of rotating the lock cylinder with the second key is rotating the lock cylinder in a second rotating direction opposite to the first rotating direction.

13. The method as claimed in claim 12, wherein the first rotating direction for rotating the lock cylinder with the first key is clockwise.
